(19) United States
(12) Patent Application Publication
(10) Pub. No.: US 2023/0234012 A1
(43) Pub. Date: Jul. 27, 2023

(54) MICRO-FLUIDIC SYSTEM AND METHOD

(71) Applicant: IAMFLUIDICS HOLDING B.V., Enschede (NL)

(72) Inventors: Tom Kamperman, Enschede (NL); Sara Tahan Latibari, Enschede (NL); Vincent Alexander De Jong, Enschede (NL); Vasileios Trikalitis, Enschede (NL); Claas Willem Visser, Enschede (NL)

(21) Appl. No.: 18/011,728

(22) PCT Filed: Jun. 28, 2021
(86) PCT No.: PCT/IB2021/055757

§ 371 Date: Dec. 20, 2022

(30) Foreign Application Priority Data
Jun. 26, 2020 (NL) 2025932

(51) Int. Cl. B01J 2/06

(52) U.S. Cl. CPC B01J 2/06

(57) ABSTRACT

A micro-fluidic system, comprising at least one first nozzle (10) that releases at least one liquid jet (15) of a first liquid into a gaseous atmosphere and a second nozzle (20) that releases a liquid film jet (25) of a second liquid in said gaseous atmosphere. Said first jet (15) is directed to be incident of said liquid film (25) at an interaction area (50). Collecting means (40) are provided for receiving an interaction product (55) of said first and second liquid downstream of said interaction area. Support means (30) are provided, having a support surface (35) that receives and supports said liquid film (25) of said second liquid from said second nozzle (20). Said support surface (35) carries said liquid film to said interaction area (55) and said interaction area (55) is supported by said support surface (35).

The present invention relates to a micro-fluidic system, comprising first supply means, feeding a first liquid to an interaction area, and second supply means, feeding a second liquid to said interaction area, said first liquid and said second liquid being different to one another and engaging into an interaction with one another within said interaction area, wherein said first supply means release at least one liquid jet of said first liquid into a gaseous atmosphere upstream of said interaction area, wherein said second supply means release a liquid flow of said second liquid upstream of said interaction area, wherein collecting means are provided downstream of said interaction area, wherein said second supply means comprise support means having a support surface that extends at least to below said interaction area where said at least one liquid jet of said first liquid is received in said liquid flow of said second liquid, and wherein said support surface is configured to receive and support said liquid flow of said second liquid released by said second supply means and to carry said second liquid to said interaction area.

It should be noticed that the expression “micro-fluidic”, as used in conjunction with the present invention, is not only meant to refer to dimensions in the micron domain but also includes sub-micron and millimetre scale dimensions. Also the expression “liquid” should be taken broadly to encompass pure liquids as well as mixtures, solutions, suspensions, emulsions, foams, aerosols, sprays and even more complicated compound liquid systems, either homogeneous or inhomogeneous.

The expression “jet”refers both to any interrupted as well as any uninterrupted ray of liquid that has substantially a single direction of propagation. Such jet may be released with or without an initial momentum and may or may not have a modulating cross section along a propagation path. As such a jet may comprises a continuous, contiguous stream of said liquid or an array of individual, consecutive liquid droplets. Such droplets may be generated and released substantially without any initial velocity, being accelerated by a suitable force field particularly gravity, towards the interaction area. Alternatively, such droplets may be launched to have already substantial initial kinetic energy, while being optionally accelerated or decelerated along their trajectory to said interaction area. The invention accordingly encompasses both dripping and jetting and these terms will be used interchangeably throughout the present specification unless indicated explicitly otherwise.

A system and method as referred to in the opening paragraph and may be particularly useful for a production of mono-disperse particles and droplets, i.e. particles and/or droplets having substantially equal size. These uniform particles or droplets may be processed into numerous products and markets, particularly in food products, pharmaceutics and cosmetics. As compared to poly-disperse particles and droplets, they allow better product and process control. In most products, large amounts of these droplets and particles are used. The mono-dispersity allows a more precise tuning of the functional properties of the resulting material. Not surprisingly, there is a growing demand for a scalable fabrication system and method for the production of such mono-disperse particles.

The production of mono-disperse particles with a size between 10 μm and 10 mm typically involves two critical steps: (1) a dispersion of a first liquid into a amount of discrete, i.e. individual, droplets; and (2) a solidification or other modification of the droplets, particularly by in situ polymerization, cross linking, precipitation or other interaction with a second liquid. The discrete droplets may be formed by emulsification in an (immiscible) second liquid or by atomization in a gaseous atmosphere. These can be continuous processes with inherently high throughput albeit with limited shape control as a more complex, non-spherical morphology, appears difficult to produce because a spherical morphology is energetically favoured due to a reduced surface tension. Emulsification and atomization are, hence, considered as the most promising technologies for (large volume) clinical and industrial applications.

Mono-disperse particles or droplets may be created by a controlled break-up of a first liquid jet that is released in a second liquid in which the first liquid is immiscible. Controlled jet-breakup techniques include jet-cutting, vibrating jet, and spinning disk. In these controlled jet break-up techniques, the liquid jet is broken up into a chain of substantially mono-disperse droplets of equal size. To turn these mono-disperse droplets into a mono-disperse emulsion or suspension in the second liquid, the atomized or emulsified droplets need to be stabilized (in flight) before they have a change to merge, which would otherwise lead to a non-uniform and/or poly-disperse product or could cause ‘phase-separate’. The emulsified droplets can be stabilized with surfactants. However, the use of surfactants might hamper use of the product in applications that should remain surfactant-free because of environmental constraints, biological compatibility and/or user preferences for care and food products.

In contrast to emulsification, atomization by a controlled jet-breakup of the first liquid jet in a gaseous atmosphere does not require the use of an immiscible liquid and surfactants. However, also in these techniques, relatively rapid mechanisms are needed to stabilize or solidify the droplets to prevent them from merging during their flight or upon collection. A droplet solidification or hardening procedure, in which the droplets are transformed into solid micro-particles, can be a result of a physical interaction or chemical (cross-linking or polymerization) reaction. Such interactions or (cross-linking) reactions can be effected by immersing the droplets of said first liquid in another, second liquid that may comprise a suitable cross-linker Initiator material or may enter into a different physical or chemical interaction with the first liquid.

US patent application no. 2002/054912 discloses to apply a stationary liquid bath in a facile and mass production method for the collection and stabilization of droplets. Upon impact on the surface of the liquid bath, however, the droplets tend to decelerate and may land on top of each other, resulting in coalescence/merging of individual droplets. Furthermore, the droplets can deform due to impact on the liquid bath, possibly resulting in uncontrolled deformed particles. Both phenomena result in non-uniform and polydisperse products. To counteract such merging of droplets in-flight, upon and after landing, the droplets can be made repulsive by electrically charging them, for example, by applying a high-voltage external electrical field as disclosed in International patent application WO 2010/119041. Such sophisticated electrical interference, however, adds to the complexity of the process as well as the process environment, and, moreover, limits the scalability of the process.

Alternatively, the second liquid may be offered in the form of a thin dynamically flowing liquid film for interaction and stabilization of droplets of the first liquid. A continuously replenishing liquid film allows a continuous emulsion and particle production in which droplet deformation and/or merging upon ‘landing’ are minimized due to the continuously flowing medium. Such a micro-fluidic system, of the type as described in the opening paragraph, is for instance know from European patent application EP 2.020.261.

This known system is applied for multi component particle generation. It comprises a first pressurized nozzle for generating a ray of consecutive, individual droplets of a first liquid as well as a second nozzle that releases a substantially uninterrupted film of a second liquid. Said film falls under gravity to form a substantially continuous vertical curtain. The first nozzle is directed such that said ray of individual droplets will traverse said curtain in an interaction area (volume), where they will enter into a chemical or physical interaction with the second liquid. According to this known method, the droplets are shot through the relatively thin liquid film with enough inertia to prevent substantial deceleration and enable a collection of the interaction products in the form of individual particles, comprising a core of said first liquid surrounded by a shell of said second liquid, at a side of said curtain across from the side of impact.

Although in theory this known process could work, in practice it turns out extremely difficult to maintain a stable curtain that will deliver the desired compound particles in a reproducible and constant manner. The substantially free flowing liquid film appears intrinsically unstable and tends to curl up at the edges and rupture due to surface tension forces. This known system and process are, hence, less suitable for a continuous mode production of compound particles on a large scale.

A more stable thin film of a second liquid is provided by a devices and methods known from French patent 2.378.330, U.S. Pat. No. 5.186.948 and Japanese patent application JP H03 165.828. In these cases a flowing thin film of the second liquid is carried by a substrate offering a support surface at the location of the interaction area where the first liquid jet impinges. The interaction product of this interaction is carried along with the second liquid flow to be collected by collecting means downstream of said interaction area.

Although the support by the substrate provides a fixed and constant layer thickness for said second liquid at the interaction area, the resulting micro-capsules still happen to be prone to unintended deformation.

The present invention has for its object, inter alia, to provide a micro-fluidic system that allows a better control over both fluid phases and, particularly, offers an improved control over the liquid film of said second liquid at said interaction area.

A micro-fluidic system of the type as described in the opening paragraph is, according to a first aspect of the present invention, characterized in that said support means comprise a support body that provides said support surface, in that said support body is coupled to drive means that subject said support surface to a movement, and in that said drive means are controllable allowing to adjust a velocity of said surface to at least one of a velocity of said flow of said second liquid and a velocity of impact of said jet of said first liquid. According to this aspect of the invention, the continuously replenishing sheet of said second liquid, being maintained by said liquid flow, is physically supported by a moving support surface of said support means. The supporting surface aids the stabilization of the sheet of second liquid and, moreover, enables to controllably combine the first and second liquid with one another at an adjustable substrate speed. Particularly, this allows to compensate and avoid shear and/or drag forces at an interface of said support surface with said second liquid that could otherwise give rise to flow velocity disturbances over a thickness of the second liquid film. This opens a gate to further scaling and tweaking or tuning of the process to create a wide variety of modifications to the combined liquid system.

According to a second aspect of the invention, a micro-fluidic system of the type as described in the opening paragraph is characterized in that said support means comprise a support layer that provides said support surface at a first side, in that said support layer is permeable to an auxiliary fluid, particularly an auxiliary gas, and in that support layer is provided with supply means that feed said auxiliary fluid trough said support layer from an opposite side across from said first side featuring said support surface. The penetrating auxiliary fluid, particularly an auxiliary gas, aid in a further fine tuning and tweaking of the interaction environment of both liquids at the interaction area to control the interaction dynamics. The (gas) permeability properties of such gas permeable or semi-permeable support layer enables a diffusion or influx of gasses through the support layer at said support surface and into the supported liquid film, for instance to control chemical reactions with the aid of oxygen or another reaction gas.

In a third aspect of the invention, a micro-fluidic system of the type as described in the opening paragraph is characterized in that said support means comprise a cylindrical or spherical support body providing said support surface, having a curvature, at a cylindrical or spherical surface thereof. The support means may comprise for instance a drum, cylinder or a sphere that may be set in rotation, preferably with an adjustable speed of rotation.

In an embodiment, the micro-fluidic system according to the invention is characterized in that said support means comprise a support body having a substantially planar main surface, wherein said support body comprises said support surface at said main surface. This embodiment enables the formation of a liquid sheet with a gravity-induced speed over the substrate main surface. But also an extension to speeds that exceed terminal velocity under gravity is rendered feasible, by applying a preset flow velocity by the second supply means that create the sheet This allows a control of droplet/particle shape by intentionally matching or unmatching a mutual velocity difference between the sheet and the impacting droplets. This velocity (difference) influences a potential deformation and/or encapsulation of the impacting first liquid jet and, in turn, determines a shape of a resulting solidified jet or particle. Also an inclined angle of the sheet with respect to the first jet directly influences the relative lateral and perpendicular impact velocity of the droplets or jets onto the sheet. a thickness of the sheet pf second liquid will determine whether impacting droplets will reach the support surface, determining whether they will interact with the substrate or only with the free-flowing liquid. This velocity, angle as well as said sheet thickness may be controlled in a predetermined fashion.

In a preferred embodiment, the micro-fluidic system according to the invention is characterized in that said support body comprises at least one channel that is recessed at said main surface, receiving said liquid flow of said second liquid, said channel having a bottom that provides said support surface. Such channel may have elevated edges that further stabilize the liquid liquid flow into a laminar sheet, by preventing curling up of the liquid from the flat solid bottom, due to such edges acting as a liquid guiding. The edges, moreover, confine the liquid flow to its initial width and avoid spreading and associated thinning of the liquid flow over the support surface.

A further embodiment of the micro-fluidic system according to the invention is characterized in that said support surface has a micro-profile or micro-texture. Combining for instance substrate ridges or holes or depressions (dimples) with wettability patterns may be used to locally optimize the second liquid flow, for example by creating pores to create a micro-bubbles layer on the support surface to thereby diminish a viscous drag by the surface on the advancing liquid film.

In order to increase the yield of the micro-fluidic system according to the invention, a further preferred embodiment is characterized in that said first supply means comprise a first nozzle that releases at least one liquid jet, and particularly a number of liquid jets, of said first liquid into said gaseous atmosphere, being directed to said interaction area and/or said first supply means comprise a plurality of first nozzles that release a plurality of liquid jets of said first liquid, particularly mutually at least substantially parallel liquid jets, into said gaseous atmosphere, being directed to said interaction area. Specifically, such embodiments, releasing a number liquid jets of the first liquid, allow a combination of one or more parallel, converging or diverting (first) liquid jets coalescing with a substrate-supported liquid sheet of said second liquid.

In that respect, a further embodiment of the micro-fluidic system according to the invention is characterized in that said liquid flow comprises a liquid film that has a width that is wider than a multiple of a width of said at least one liquid jet. The liquid flow, in that case, will flow over a width of multiple jet diameters over said support surface to be able to receive multiple jets of the first and/or a further liquid concurrently. Such setup allows a large scale production of emulsions or dispersions by jetting one or more materials into a liquid sheet made of another (second) liquid material. The coalesced liquid materials are immediately carried away by the continuously flowing second liquid flow in the direction of the collecting means.

It has been found that the ultimate product that is obtained by the system according to the invention is greatly influenced by the relative impact velocity of the first liquid jet relative to the flowing stream of the second liquid. This relative impact velocity depends, apart from the velocity of the first and second liquid, on an angle of impact between the liquid jet and said stream of said second liquid. In order to be able to adjust this angle, a further specific embodiment of the micro-fluidic system according to the present invention is characterized in that said first supply means are adjustable to release said at least one first liquid jet in a propagation direction towards said support surface at an inclined jet angle that may be set between zero and 75 degrees, particularly between 0 and 60 degrees.

In order that the second liquid will have a stable, uniform flow over said support surface a certain alignment between the flow of second liquid and said support surface might be favourable. To that end, a further specific embodiment of the micro-fluidic system according to the invention is characterized in that said second supply means release said liquid flow to form a liquid film onto said support surface.

A further specific embodiment of the micro-fluidic system according to the invention is characterized in that said support body is provided with temperature control means that provide a temperature controlled support surface. This embodiment allows to regulate the substrate temperature of the support body, notably the support surface, to thereby control for instance the liquid viscosity and/or reaction speeds. If the viscosity of the substrate-supported liquid is controlled, it can for instance be increased to prevent the transition from laminar flow to turbulent flow, or it can be modified to alter the impact dynamics of the incoming first jet(s), thereby modifying a particle shape of a resulting interaction product.

Still a further particular embodiment of the micro-fluidic system according to the invention is characterized in that said support means comprise a support layer that provides said support surface and that is permeable to an auxiliary fluid, particularly an auxiliary gas, and in that support layer is provided with supply means that feed said auxiliary fluid trough said support layer from a side across from said support surface. The (gas) permeability properties of such gas permeable or semi-permeable support layer enables a diffusion or influx of gasses through the support layer at said support surface and into the supported liquid film, for instance to control chemical reactions with the aid of oxygen or another reaction gas.

The support surface may be held stationary while the liquid film is flowing over it. Alternatively a specific embodiment of the micro-fluidic system according to the invention is characterized in that said support means comprise a support body, providing said support surface, that is coupled to drive means that subject said support surface to a movement, particularly a lateral movement parallel to said liquid film, more particularly to a reciprocal movement, even more particularly to a rotation. This embodiment allows to set a substrate surface speed when rotating, sliding or vibrating said support body to thereby influence the relative velocity of impact of the impinging liquid jet relative to the liquid sheet. The support means may comprise a cylindrical or spherical support body providing said support surface, having a curvature, at a cylindrical or spherical surface thereof, for instance like a drum, cylinder or a sphere that may be set in rotation, preferably with an adjustable speed of rotation.

Also an orientation of the support body relative to the horizon may be adjusted by suitable drive means to control its angle and, hence, an effect of gravity on the flow of the liquid film. Also the angle of the liquid film with respect to the impacting liquid jet or droplet train may be controlled in this manner. This angle directly influences the relative lateral and perpendicular impact velocity of the droplets or jets onto the film in a controlled fashion. Their relative velocity influences the potential deformation and encapsulation of the impacting liquid, in turn determining a shape of a solidified jet or particle.

The present invention further relates to a method of operating a micro-fluidic device in accordance with the present invention. To that end, such method is characterized in that said at least one liquid jet is released as at least one ray of consecutive, individual liquid droplets containing said first liquid, and in that said second liquid is released on said support surface as a substantially continuous film of said second liquid.

In order to aid a stability and reproducibility of the process, a preferred embodiment of the method according to the invention is characterized in that said film of said second liquid is released with a substantially laminar flow of said second liquid, at least at an interface with said support surface. By this avoiding turbulence at said interface a stable micro-fluidic volume is created in which a droplet of said first liquid may be received to interact or react with the second liquid.

In a first mode of operation, said method according to the invention may be characterized in that said film of said second liquid is released with a controlled thickness on said support surface that exceeds an penetration depth of said liquid droplets at said interaction area. This mode secures that an impacting droplet is sufficiently decelerated within the liquid film to avoid hitting the substrate surface. An interaction is with the second liquid only. In a second mode of operation, on the other hand, the method is characterized in that said film of said second liquid is released with a controlled thickness on said support surface that undershoots an penetration depth of said liquid droplets at said interaction area. In this case the droplets will dynamically interact with the support surface of the support body that may be resilient or non-resilient and may thereby influence a shape and morphology of the resulting particles or droplets.

The present invention enables the formation of a liquid film with a gravity-induced speed, but also allows an extension to speeds that exceed terminal velocity under gravity, by applying a preset flow velocity from the entry where the film is formed. A specific embodiment of the method according to the invention is thereto characterized in that said liquid film is released at an elevated initial velocity to reach a velocity exceeding gravitational terminal velocity and, particularly, initially exceeding gravitational terminal velocity. Also this increased initial and final velocity may be adjusted to influence a resulting droplet/particle shape by matching or unmatching the velocity difference between the film of the second liquid and the impacting liquid jet.

The first liquid may be a single liquid but may also comprise a composition of several liquids. In this respect, a specific embodiment of method according to the invention is characterized in that said first liquid is released as a compound liquid jet, comprising composite liquid droplets of at least two different liquids that form for instance a core of one liquid surrounded by a shell of the other liquid, a mixture, a suspension, an emulsion, or Janus-type (multi-compartmentalized) compound droplets. Likewise also the second liquid may be provided as a composite film of several films of mutually different liquids on top of one another. This creates a wide variety of opportunities to tailor and resulting particles or droplets by means of consecutive interactions with different liquids.

Particularly, the method according to the invention is characterized in that the first liquid and the second liquid comprise liquids having different surface tensions, particularly said second liquid having a lower surface tension than said first liquid. In a first mode of operation, the method according to the invention is characterized in that the first liquid and the second liquid are, at least partly, immiscible and in that an emulsion is formed out of the first and second liquid in or downstream of the interaction area. Specifically said emulsion may be formed directly in said interaction area or further downstream, for instance by or in the collection means.

In a further mode of operation, the method according to the invention is characterized in that the first liquid and the second liquid enter into a chemical reaction or physical interaction with one another to solidify into a suspension or dispersion at the interaction area. Such solidification reaction entails particularly a polymerization of a liquid jet of monomer solution that is brought into contact with a second liquid conveying a polymerization initiator, either of chemical, thermal or radiant nature, or may involve cross-linking or thermal solidification.

As a specific embodiment, the method of the invention may be characterized in that said first liquid comprises at least one polymer, particularly a polysaccharide or protein, in that an aqueous solution of a cross-linker and/or polyvalent metal salt is applied as said second liquid to form said liquid film on said support surface, and in that said first liquid is allowed to cure upon a cross-linking reaction with said second liquid within said interaction area.

The invention will hereinafter be described in further detail with reference to one or more exemplifying embodiments and an accompanying drawing. In the drawing:

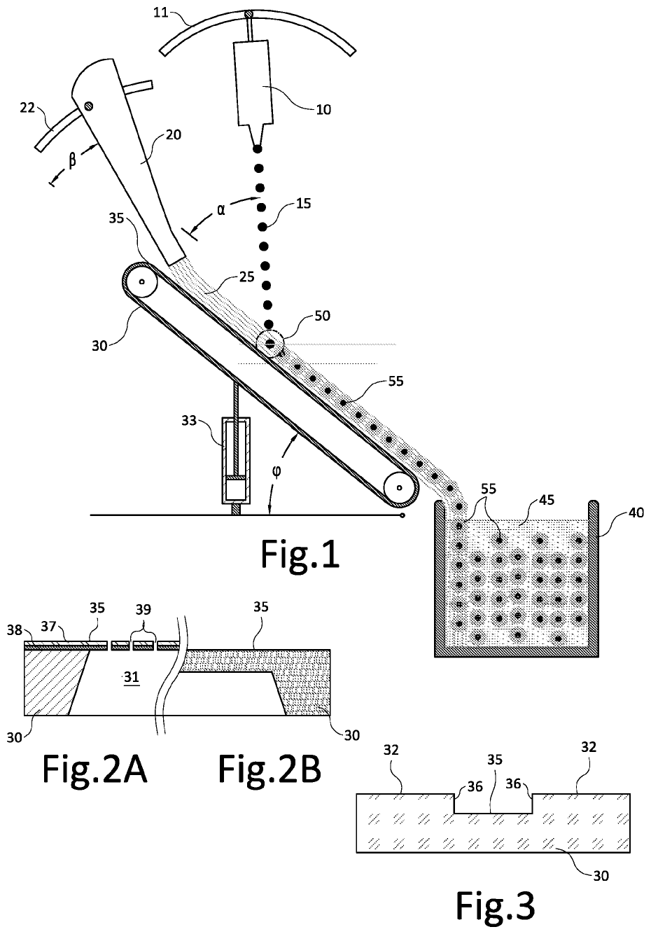

FIG. 1 shows the basic setup of an example of an micro-fluidic system according to the invention;

FIG. 2A shows a cross section of a support body in a first alternative embodiment of a micro-fluidic system according to the invention; and

FIG. 2B shows a cross section of a support body in a second alternative embodiment of a micro-fluidic system according to the invention;

FIG. 3 shows a cross section of a support body in a third alternative embodiment of a micro-fluidic system according to the invention;

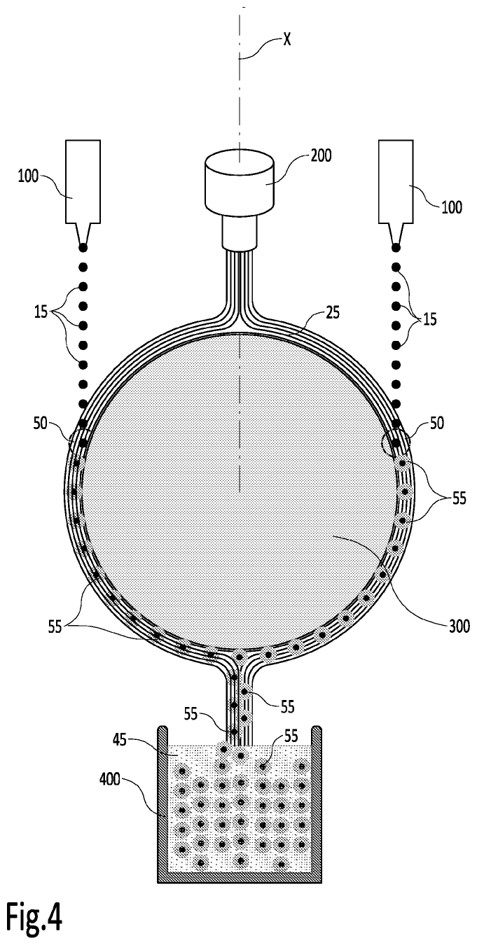

FIG. 4 shows a support body in a fourth alternative embodiment of a micro-fluidic system according to the invention; and

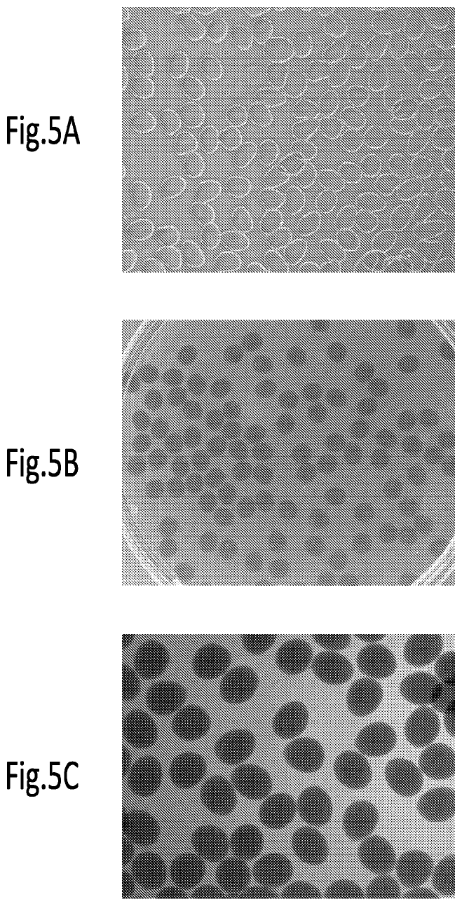

FIG. 5A-5C show photographic pictures of samples that were produced using a micro-fluidic system according to the invention.

Please note that the figures are purely schematic and not drawn to scale. Particularly certain dimensions may be exaggerated to greater or lesser extent in order to elucidate certain aspects of the invention. Like parts are generally designated by a same reference numeral throughout the drawing.

FIG. 1 is a schematic representation of a basic setup of a micro-fluidic system according to the invention. The system comprises a first nozzle 10 for releasing a liquid jet 15 of a first liquid. In this example this nozzle 10 is fed with a 0.5% (w/v) sodium alginate (Wako 80-120 Cp) solution is water at a flow rate of approximately 2.5 ml per minute. The nozzle has a diameter of 100 micron and is modulated at a frequency of 5 kHz by a vibrating element like an oscillator to release said liquid jet in the form of a droplet train of a series individual, consecutive alginate droplets, as shown in the figure. These droplets will have a substantially spherical shape of about 100 micron in diameter. Alternatively the liquid jet may be formed as a contiguous trail of liquid having a constant or regularly varying cross section, being modulated by a suitable modulating means connected to or integrated in the nozzle 10.

As shown in FIG. 1 the first nozzle 10 is provided with adjustment means 11 that allow to vary its orientation. Specifically a jet angle α of the emanating jet 15 may be set to a desired value between a lower and maximum value, for instance between 30 and 40 degrees, relative to a substrate surface 35 that will be described hereinafter. The nozzle may also be suspended to be displaceable laterally, being carried by appropriate displacement means. Also several first nozzles 10 may be placed next to one another to carry out the same or different processes according to the invention in parallel and to facilitate an upscaling of the process.

The system further comprises a second nozzle 20. Different to the first nozzle 10, this second nozzle 20 does not release an interrupted jet of droplets, but instead a continuous film 25. This film 25 is formed by a second liquid that is different from the first liquid. In this case said second liquid 25 comprises a 0.2 M calcium chloride solution in water to which 10% (w/v) ethanol is added. This solution is supplied to the second nozzle 20 at an inlet pressure of the order of 0.25 khPa and is released with an initial film width of the order of one to a few millimetre.

According to an aspect of the present invention the micro-fluidic provides a support body 30 having a support surface 35 that receives and support the film 25 that is released by said second nozzle 20. The support body 30 comprises a moving continuous belt, but may also be formed by a displaceable substrate of glass or a displaceable substrate of another solid material, like for instance a sheet of plastic. As shown in FIG. 1, the second nozzle 20 as well as the support body 30 are provided with adjustment means 22,33 that allow to adjust their respective orientation β, φ with respect to the horizon. This setup particularly allows to adjust their mutual angle such that thereby an angle of incidence β of the second film 25 onto said support surface 35 may be varied. Drive means (not shown) are provided that set said continuous belt or solid substrate in motion with a velocity V. These drive means allow to adjust a planar velocity V of said support surface at an interaction area where the first liquid jet 15 impinges. Particularly shear and drag forces at an interface between the second liquid and the support surface may thereby be counteracted that could other wise give rise to flow rate disturbance over en thickness of the second liquid film.

The supported film 25 of said second liquid is carried by said support body 30 to collecting means 40, like a container, in which the second liquid 45 is collected and, optionally, re-circulated back to the second nozzle 20. The first nozzle and second nozzle 20 are suspended such that the ray of droplets 15 of said first liquid will enter said film 25 of said second liquid in an interaction area 50 while said film 25 is carried and supported by said support body 30. The support surface 35 stabilizes the second liquid film 25 that will absorb said jet droplets 15.

The droplets 15 of said first liquid will interact with said second liquid 25 at said interaction area 50. In this example, the second liquid has a lower surface tension than said first liquid, which facilitates the encapsulation, coalescence or uptake of the material of said droplets 15. Due to this mutual difference in surface tension between both liquids 15,25, the droplets 15 of the first liquid are surrounded by a shell of second liquid 25 to form compound droplets 55, if the first and second liquid are mutually immiscible liquids. These droplets 55 form micro-capsules containing a core of the first liquid encapsulated by the second liquid 25 to create a suspension 45 of such micro-capsules that may be collected by the collecting means 40. If the liquids would be miscible, the same will result in a mixture or compound solution that may chemically or physically react. The droplets 15 of said first liquid may for instance solidify into particles, once they are exposed to the second liquid.

The core-shell capsules between the first and second liquid may be subjected to a solidifying agent, temperature or radiation downstream of the interaction area to harden the shell. Alternatively, the droplets 15 may be provided as core-shell droplets using, for instance, a coaxial nozzle 10 in-air micro-fluidics technology (drop-jet coalescence) to achieve core-shell compound droplets during flight, prior to impact with the liquid sheet 25 in which they may stabilize or solidify. The flowing film of said second liquid 25 will drag the droplets further downstream where they will be collected finally by the collecting means 40. The alginate capsules that are produced appear almost identical in size and shape as shown in FIG. 5A. It turns out that such micro-fluidic system allows a stable and reproducible physical interaction or chemical reaction on a millimetre to micron scale to deliver millimetre, micrometre or sub-micron sized particles and/or compound droplets, in a range between a few nanometre and the order of ten millimetre, that allows upscaling to an increased, particularly industrial scale.

FIG. 1 shows an interaction between merely two liquids. The invention, however, allows to add further liquids and/or other fluids. As an example a number of first nozzles 10 may be placed in parallel to release a number of jets of the first liquid that will enter the liquid film 25 at various interaction areas 50 substantially concurrently. But also more that two liquids may be involved by adding further jet nozzles to release continuous or dis-continuous jets of first and further liquids and also further films of further liquids may be released onto the substrate prior, past, on top or below the film of said second liquid.

Besides liquids, also gasses may be joined into the interaction. To that end a substrate 30 may be employed as support body, having a top layer that is permeable to such gas while offering the support surface to the second liquid. FIGS. 2a and 2B show examples of a support body that may be used in such embodiments.

In FIG. 2A a perforated silicon nitride layer 37 is provided on a monolithic silicon substrate 30 with an intervening silicon oxide layer 38, said nitride layer 37 and oxide layer 38 having multiple tiny pores 39 that allow a passage of a reaction gas. Said reaction gas may be supplied by suitable supply means, not shown, through cavity 31 in said support substrate 30 underneath said top layer 37,38. The pores 39 are hydrophobic such that the liquid film 25 will run over it without entering the pores 39, while gas is being fed into the liquid flow 25. Said pores may be of sub-micron to millimetre scale and may be created by etching or micro-machining techniques.

Alternatively a porous, particularly a micro-porous, substrate 30 may be used as support body, as shown in FIG. 2B. This substrate 30 is for instance a foam body of a suitable polymer foam having an open cell structure that allows a passage of a gas while being hydrophobic to block a penetration of the second liquid.

Instead of having a flat, planar main surface 32, the support body 30 may also be configured to have one or more channels at a main surface. FIG. 3 shows such an embodiment in which a gutter or trench is formed by a recessed portion at said main surface 32. A bottom of said channel forms the support surface that will receive and carry the liquid film that is released from the second nozzle. The liquid film 25 will, in that case, not only be stabilized by the support surface 35 provided by the bottom of such channel, but will also be confined by both side walls 36 that further stabilize the liquid film and avoid spreading of the surface 32. Optionally, these side walls 32 may additionally be configured to have overhangs that further facilitate liquid pinning, thereby acting as ‘liquid phase guides’. FIG. 5B shows collected particles that were produced in this manner having an almost identical, mono-disperse diameter of around 1895 micron±64 micron.

The support surface may be stationary, like in the preceding examples, but may also be moving at a velocity. Particularly, the support surface may be provided by an endless conveyer belt or a rotating drum, cylinder or sphere. Providing a liquid film on a spherical surface has the advantage that no boundary interaction are to be expected alongside the interaction area. This particularly facilitates a parallel setup of several first nozzles to release several liquid jets of a first liquid to a common liquid film of a second liquid that is supported by a spherical surface.

FIG. 4 shows a typical setup of a micro-fluidic system according to the invention in which a liquid film of a second liquid is supported by a spherical support surface. The system comprises a number of first nozzles 100 arranged at regular intervals around an axis of rotation X of a spherical support body 300. Instead of jetting the first liquid with a substantial initial velocity, the nozzles of the current example release the first liquid by dripping droplets 15 with hardly any velocity. The first liquid is supplied to the nozzles 100 at a stable flow rate that allows the liquid to initially adhere to the nozzle outlet due to surface tension forces. The stable flow causes such a hanging droplet to deploy until, finally, the gravitational forces exceed said surface tension forces and the droplet 15 detaches from to nozzle 100. The nozzles 100, that are used in this example, are 150 micron precision cores by Subrex. Using these nozzles a 1% low viscosity alginate solution from Wako is ejected at a constant pressure of approximately 0.2 bar. The droplets 15 will accelerate to a terminal velocity at which they impacts an interaction area 50 at a surface of the spherical body 300.

At said interaction area 50, the spherical support body 300 carries a sheet 25 of a second liquid that has been sprayed on top of its surface by a second nozzle 200. This will create a film 25 of diminishing film thickness that spreads around the spherical support surface 300 and eventually will leave the support body 300 at its bottom to be collected by suitable collecting means 400 or to be carried further downstream. The second liquid 25 is a calcium chloride solution to produce almost identical alginate bodies 55 as shown in FIG. 5C, having a almost identical shape and size of around 3007 micron±113 micron.

Although the invention has been described with reference to merely a limited number of exemplifying embodiments, it will be appreciated that the present invention is by no means limited to those embodiments. On the contrary many more embodiments and variations are feasible within the spirit and scope of the present invention without requiring a skilled person to exercise any inventive skill. As such the liquids used in the example of FIG. 1 may be replaced by other liquids that will have an interaction with one and another. Apart from physical interactions due to a difference in surface tension, causing the first liquid to be encapsulated by the other, second liquid, or the other way around, also chemical reaction are envisaged within said interaction area, for instance a solidification of first liquid droplets to solid particles upon reaction with the second liquid. Also the dimensions that were given, are merely an indication but may be set larger or smaller in practice to serve a particular application.

1. A micro-fluidic system, comprising first supply means, feeding a first liquid to an interaction area, and second supply means, feeding a second liquid to said interaction area, said first liquid and said second liquid being different to one another and engaging into an interaction with one another within said interaction area, wherein said first supply means release at least one liquid jet of said first liquid into a gaseous atmosphere upstream of said interaction area, wherein said second supply means release a liquid flow of said second liquid upstream of said interaction area, wherein collecting means are provided downstream of said interaction area, wherein said second supply means comprise support means having a support surface that extends at least to below said interaction area where said at least one liquid jet of said first liquid is received in said liquid flow of said second liquid, and wherein said support surface is configured to receive and support said liquid flow of said second liquid released by said second supply means and to carry said second liquid to said interaction area, wherein said support means comprise a support body that provides said support surface, wherein said support body is coupled to drive means that subject said support surface to a movement, and wherein said drive means are controllable allowing to adjust a velocity of said surface to at least one of a velocity of said flow of said second liquid and a velocity of impact of said jet of said first liquid.

2. The micro-fluidic system according to claim 1, wherein said movement of said support surface is effected by a lateral movement of said support body parallel to said liquid film, more particularly to a reciprocal movement of said support body.

3. The micro-fluidic system according to claim 1, wherein said movement of said support surface is effected by a rotation of said support body.

4. The micro-fluidic system according to claim 3, wherein said support body is a continuous belt, a cylinder, a cone or a sphere.

5. A micro-fluidic system, comprising first supply means, feeding a first liquid to an interaction area, and second supply means, feeding a second liquid to said interaction area, said first liquid and said second liquid being different to one another and engaging into an interaction with one another within said interaction area, wherein said first supply means release at least one liquid jet of said first liquid into a gaseous atmosphere upstream of said interaction area, wherein said second supply means release a liquid flow of said second liquid upstream of said interaction area, wherein collecting means are provided downstream of said interaction area, wherein said second supply means comprise support means having a support surface that extends at least to below said interaction area where said at least one liquid jet of said first liquid is received in said liquid flow of said second liquid, and wherein said support surface is configured to receive and support said liquid flow of said second liquid released by said second supply means and to carry said second liquid to said interaction area, wherein said support means comprise a support layer that provides said support surface at a first side, wherein said support layer is permeable to an auxiliary fluid, particularly an auxiliary gas, and wherein support layer is provided with supply means that feed said auxiliary fluid trough said support layer from an opposite side across from said first side featuring said support surface.

6. A micro-fluidic system, comprising first supply means, feeding a first liquid to an interaction area, and second supply means, feeding a second liquid to said interaction area, said first liquid and said second liquid being different to one another and engaging into an interaction with one another within said interaction area, wherein said first supply means release at least one liquid jet of said first liquid into a gaseous atmosphere upstream of said interaction area, wherein said second supply means release a liquid flow of said second liquid upstream of said interaction area, wherein collecting means are provided downstream of said interaction area, wherein said second supply means comprise support means having a support surface that extends at least to below said interaction area where said at least one liquid jet of said first liquid is received in said liquid flow of said second liquid, and wherein said support surface is configured to receive and support said liquid flow of said second liquid released by said second supply means and to carry said second liquid to said interaction area, wherein said support means comprise a cylindrical or spherical support body providing said support surface, having a curvature, at a cylindrical or spherical surface thereof.

7. The micro-fluidic system according to claim 1, wherein said support means comprise a support body having a substantially planar main surface, wherein said support body comprises said support surface at said main surface.

8. The micro-fluidic system according to claim 1, wherein said support body comprises at least one recessed channel at said main surface, receiving said liquid flow of said second liquid, said channel having a bottom that provides said support surface.

9. The micro-fluidic system according to claim 8, wherein said channel is formed in a substantially straight gutter between opposite side walls or ridges that confine said support surface on either side of said channel.

10. The micro-fluidic system according to claim 1, wherein said support surface has a micro-profile or micro-texture.

11. The micro-fluidic system according to claim 1, wherein said first supply means comprise a first nozzle that releases at least one liquid jet, and particularly a number of liquid jets, of said first liquid into said gaseous atmosphere, being directed to said interaction area.

12. The micro-fluidic system according to claim 1, wherein said first supply means comprise a plurality of first nozzles that release a plurality of liquid jets of said first liquid, particularly mutually at least substantially parallel liquid jets, into said gaseous atmosphere, being directed to said interaction area.

13. The micro-fluidic system according to claim 1, wherein said first supply means are adjustable to release said at least one first liquid jet in a propagation direction towards said support surface at an inclined jet angle that may be set between zero and 75 degrees, particularly between 0 and 60 degrees.

14. The micro-fluidic system according to claim 1, wherein said second supply means release said liquid flow to form a liquid film onto said support surface.

15. The micro-fluidic system according to claim 1, wherein said liquid flow comprises a liquid film that has a width that is wider than a multiple of a width of said at least one liquid jet.

16. The micro-fluidic system according to claim 1, wherein said support body is provided with temperature control means that provide a temperature controlled support surface.

17. The micro-fluidic system according to claim 1, wherein said support means comprise a support layer that provides said support surface and that is permeable to an auxiliary fluid, particularly an auxiliary gas, and wherein support layer is provided with supply means that feed said auxiliary fluid trough said support layer from a side across from said support surface.

18. The micro-fluidic system according to claim 5, wherein said support means comprise a support body, providing said support surface, that is coupled to drive means that subject said support surface to a movement, particularly a lateral movement parallel to said liquid film, more particularly to a reciprocal movement, even more particularly to a rotation.

19. The micro-fluidic system according to claim 1, wherein said support means comprise a cylindrical or spherical support body providing said support surface, having a curvature, at a cylindrical or spherical surface thereof.

20. A method of operating a micro-fluidic system according to claim 1, wherein said at least one liquid jet is released as a ray of consecutive, individual liquid droplets containing said first liquid, and wherein said second liquid is released on said support surface as a substantially continuous film of said second liquid.

21. The method according to claim 20, wherein said film of said second liquid is released with a substantially laminar flow of said second liquid, at least at an interface with said support surface.

22. The method according to claim 20, wherein said film of said second liquid is released with a controlled thickness on said support surface that exceeds a penetration depth of said liquid droplets in said interaction area.

23. The method according to claim 20, wherein said film of said second liquid is released with a controlled thickness on said support surface that undershoots an penetration depth of said liquid droplets at said interaction area.

24. The method according to claim 20, wherein said liquid film is released at an elevated initial velocity to reach a velocity exceeding gravitational terminal velocity and, particularly, initially exceeding gravitational terminal velocity.

25. The method according to claim 20, wherein said first liquid is released as a compound liquid jet, comprising composite liquid droplets of at least two different liquids that form a core of one liquid surrounded by a shell of the other liquid, respectively.

26. The method according to claim 20, wherein the first liquid and the second liquid comprise liquids having different surface tensions, particularly said second liquid having a lower surface tension than said first liquid.

27. The method according to claim 20, wherein the first liquid and the second liquid are, at least partly, immiscible and wherein an emulsion is formed out of the first and second liquid in or downstream of the interaction area.

28. The method according to claim 20, wherein the first liquid and the second liquid enter into a chemical reaction or physical interaction with one another to solidify into a suspension or dispersion at the interaction area.

29. The method according to claim 28, wherein said first liquid comprises at least one polymer, particularly a polysaccharide or protein, wherein an aqueous solution of a cross-linker and/or polyvalent metal salt is applied as said second liquid to form said liquid film on said support surface, and wherein said first liquid is allowed to cure upon a cross-linking reaction with said second liquid within said interaction area.
